(19) United States
(12) Patent Application Publication
(10) Pub. No.: US 2026/0357526 A1
(43) Pub. Date: Nov. 12, 2026

(54) Road construction machine with control of a function system in accordance with an available amount of energy

(71) Applicant: Wirtgen GmbH, Windhagen (DE)

(72) Inventors: Maximilian Kleingräber, Warendorf (DE); Markus Bach, Bonn (DE)

(21) Appl. No.: 19/667,783

(22) Filed: May 5, 2026

(30) Foreign Application Priority Data
May 9, 2025 (DE) 10 2025 117 991.3

(51) Int. Cl. E01C 23/088; B60L 1/00; B60L 3/00; B60L 50/75; E01C 23/12

(52) U.S. Cl. CPC E01C 23/088; B60L 1/003; B60L 3/00; B60L 50/75; E01C 23/127; B60L 2200/40

(57) ABSTRACT

A road construction machine includes a machine frame and a traveling gear configured to support the machine frame on the ground. A function system is supported by the machine frame and includes a plurality of functional modules, including a work module configured to work on a work object distinct from the road construction machine and at least one travel drive configured to provide self-propelled movement of the road construction machine on the ground. An energy supply system is configured to supply the function system with energy. A controller is configured to control at least the function system. The controller is further configured to control the function system and/or the energy supply system based at least in part on at least one availability parameter representing an amount of energy deliverable by the energy supply system.

### RELATED APPLICATIONS

The present application claims priority to German Patent Application Ser. No. DE 10 2025 117 991.3, filed May 9, 2025, which is incorporated herein by reference.

### BACKGROUND

### Field of the Disclosure

The present application relates to a road construction machine, comprising:
a machine frame,
a traveling gear standing in rollable fashion on the ground, which traveling gear is connected to the machine frame and supports the machine frame above the ground,
a function system supported by the machine frame having a plurality of functional modules, comprising:
   as a first functional module, a work module for working on a work object distinct from the road construction machine, and
   as a second functional module, at least one travel drive for self-propelled movement of the road construction machine on the ground,
an energy supply system for supplying the function system with energy and
a control apparatus for controlling at least the function system.

Such a road construction machine is generally known as a self-propelled road construction machine. On account of its travel drive, it is able to move and maneuver independently. Moreover, using its work module, it is able to work on a work object such as the ground, for example.

### DESCRIPTION OF THE PRIOR ART

In this connection, special reference is made to the road construction machine in the form of a road milling machine known from DE 10 2021 133 306 A1. The known road milling machine has a control apparatus that is able to estimate, on the basis of various parameters, a resource expenditure to be expected in the performance of the work task. The parameters used for this purpose take into account the operation of the function system, the work task to be performed as well as the structure and organization of the construction site on which the road milling machine is used.

The resource expenditure estimation made possible in this manner facilitates from a technical standpoint the planning of future uses of the road milling machine on construction sites and from a business standpoint the preparation of corresponding bids.

Furthermore, DE 10 2015 111 249 A1 discloses a road construction machine in general and a road milling machine in particular, the control apparatus of which is designed to ascertain and, if applicable, adjust machine parameters with which the road construction machine is operated for performing a work task by taking into account material properties of the ground to be worked on in accordance with an expected wear behavior of the earth working tools used.

It is thus generally known to operate a road construction machine for the performance of a specific work task in accordance with relevant boundary conditions in such a way that in a selected parameter range, such as tool wear for example, an improved, preferably an optimal, operating behavior is achieved. This is immediately apparent in the aforementioned example of tool wear, as excessive tool wear may make maintenance necessary at an earlier time and may thus undesirably shorten the potential duration of use of the road construction machine on a construction site.

The vast majority of self-propelled road construction machines deployed on construction sites at the time of the present application have a diesel internal combustion engine as a central power plant, where the energy required by the road construction machine to perform its work task is generated and supplied to the functional modules of the function system of the road construction machine.

The diesel fuel required for generating the energy in the known road construction machines is taken for granted by every road construction machine dispatcher and by every machine operator, who tacitly assume without further reflection that there is always a sufficient supply available.

Contrary to this widespread assumption, recent crises have shown on the one hand that even fuels that were previously considered to be readily available can become subject to supply shortages. On the other hand, road construction machines also increasingly use energy sources other than petroleum-based fuels to provide the operating power of the road construction machine, which due to differing production and storage mechanisms, generally exhibit availability patterns that differ from those of the aforementioned petroleum-based fuels.

### SUMMARY OF THE DISCLOSURE

The objective of the present disclosure is to address the aforementioned changes in the energy supply of road construction machines and to ensure that road construction machines can be deployed at their respective construction sites, including from an energy perspective, while avoiding undesirable downtime and stoppages.

The present disclosure achieves this objective in a road construction machine of the type mentioned at the outset in that the control apparatus is additionally designed to control the function system and/or the energy supply system on the basis of at least one availability parameter, wherein the at least one availability parameter represents an amount of energy that can be delivered by the energy supply system.

The control apparatus typically controls the function system by quantitatively or at least qualitatively adjusting at least one operating parameter of at least one of its functional modules.

The control apparatus typically controls the energy supply system by quantitatively or at least qualitatively adjusting at least one of its operating parameters.

The availability parameter represents the amount of energy that the energy supply system can deliver to the function system and thus makes it possible, in principle, to predict whether a work task can be fully completed by the road construction machine without further energy storage measures. Knowledge of the available amount of energy is also a prerequisite for ascertaining the duration for which the road construction machine can continue to be operated under defined operating conditions.

For example, a data memory of the control apparatus may contain a work profile, which includes an average energy consumption per unit of time of the road construction machine. Multiple such work profiles may also be stored. In the case of multiple stored work profiles, at least one suitable work profile may be stored for each of the various work tasks, it then being possible to select the most suitable of the available work profiles for the work task currently to be performed by the road construction machine to serve as the basis for ascertaining a future energy requirement. With the knowledge of a future energy requirement, it is possible to estimate, based on the availability parameter and the available quantity of energy that it represents, whether a work task already begun or about to begin can be completed without further measures.

The two functional modules mentioned at the outset need not be the only functional modules of the road construction machine and generally are not. However, they are those functional modules that are necessarily present in the road construction machine. Thus, the function system may include a further functional module that comprises hydraulic and/or electric and/or pneumatic actuators to drive components into motion relative to the machine frame. Depending on their function, the actuators may be assigned to functional modules, for example to a steering module for steering the road construction machine in travel operation, to a lifting module for adjusting the height of the machine frame above the ground, and to other adjustment actuators, for example for lifting or lowering a roof of the operator platform, for swiveling a running unit of the traveling gear or a massive flap on the machine body of the road construction machine. Additionally or alternatively, at least one functional module may be a stationary functional module free of actuators and yet require energy to perform its function. For example, the lighting of the road construction machine can be a functional module as can the control of the road construction machine.

Frequently, a pure travel operation, when the travel drive is operated while the work module is at a standstill or at least idling, is an operating state of the road construction machine with low energy consumption. The same applies to the aforementioned possible additional functional modules that are not work modules. As a general rule, the energy consumption of the work module over a given period is substantially higher, in particular many times higher, than the energy consumption of the travel drive or other functional modules. Using different work profiles, it is thus possible to take into account differing activity shares of the various functional modules of the road construction machine in the overall operation of the road construction machine. Consequently, it is possible to determine the future energy requirement of the road construction machine or of select functional modules thereof as accurately as possible.

This can be illustrated in the following example: depending on the specific work task to be performed, a work profile can be selected from a plurality of work profiles that assigns to the work module the most appropriate amount of work energy required for completing the work task. To ensure that the road construction machine retains a desired residual maneuverability, a residual amount of maneuvering energy may be reserved in the corresponding work profile for this residual maneuverability. This residual amount of maneuvering energy may be subtracted from the total amount of energy available on the road construction machine as represented by the availability parameter, possibly by applying a safety margin, so that only the resulting remaining energy amount is available for the work of the current work task and used to ascertain whether or not the available usable energy amount exceeds the work energy amount. In this way, it is possible to ensure, for example, that the road construction machine can definitely be loaded onto a transport vehicle using its own power.

Depending on the particular features of the respective construction site, for example the distances to be traveled, it may be possible to select within the work profile a suitable sub-profile for the travel and maneuvering activity from among several sub-profiles, which reflects the energy requirement of the travel operation as accurately as possible.

The road construction machine may comprise at least one sensor, preferably a plurality of sensors, which detect an available energy quantity in or on the road construction machine. The at least one sensor is preferably connected in signal-transmitting fashion to the control apparatus of the road construction machine, so that a sensor signal representing the available energy quantity or partial energy quantity detected by the sensor can be transmitted to the control apparatus for forming the availability parameter.

The road construction machine is able to control not only the function system, that is, at least one functional module, in accordance with the availability parameter, but, additionally or alternatively, is able to control the energy supply system in accordance with the availability parameter, for example via a power circuit. In this way, the control apparatus is able to ensure that the available energy quantity represented by the availability parameter suffices for a remaining operating time that is predetermined or ascertained by the control apparatus.

The amount of available energy represented by the availability parameter may be an energy reserve, for example a fuel reserve for an internal combustion engine and/or a fuel reserve for a fuel cell system and/or a charge of a rechargeable electrical energy store such as a battery, for example. The list is provided by way of example and is not exhaustive. Depending on the energy source and energy supply, at least one suitable sensor may be provided for detecting the amount of energy on the road construction machine.

In addition or as an alternative to the prospective approach described above, in which the availability parameter is an input variable and represents an energy quantity that can be supplied for an upcoming work task to be performed and is thus available, the availability parameter may also be a target variable in a retrospective approach and represent a remaining energy quantity that can be supplied or is available after the completion of a past work task.

To clarify, it should be emphasized that although the availability parameter represents an available amount of energy as described above, it need not necessarily be a numerical value expressed in units of energy, for example in joules. The availability parameter, for example, already represents an available amount of energy if it specifies with sufficient accuracy the quantity of an energy source which, based on data relationships stored in a data memory or in the operating program of the control apparatus, correlates with work that can be performed by the function system, for instance, by taking into account one or multiple necessary conversions of a provided form of energy into a form of energy that can actually be directly used by a functional module and by taking into account the realistically achievable efficiency of one or multiple energy converters involved.

Although the aforementioned availability parameter, by representing an available energy quantity, provides the control apparatus with a basis for controlling the function system and/or the energy supply system, the function system and/or the energy supply system may be controlled more precisely in accordance with the availability parameter if the availability parameter comprises or is a time-related availability parameter, which represents an amount of energy deliverable per unit of time by the energy supply system. In particular, this refers to an amount of energy that can be supplied to the function system per unit of time, since controlling the function system and/or the energy supply system in accordance with the availability parameter is preferably to ensure that the function system, i.e., at least one functional module of the same, has sufficient energy available for continued operation until a predetermined or ascertained remaining operating time is reached, in order to avoid a premature termination of operation or an unplanned shutdown.

For it may be the case, and this is likely even the norm, that a certain quantity of energy is indeed nominally available, yet this energy quantity cannot be accessed at will and is therefore not immediately usable. Thus, an electrical battery may store a relatively large amount of electrical charge. Yet, due to the battery's internal resistance, this electrical charge cannot be accessed instantaneously but only at a certain rate. A further example is the fuel supply of a fuel cell, which likewise cannot be converted into electrical energy instantaneously but only in accordance with the fuel cell's performance characteristics, making it usable for one or multiple electrical consumers.

Essentially, this also applies to the road construction machine mentioned at the outset that has a diesel internal combustion engine as a central power plant, since the internal combustion engine is also not able to convert the diesel instantaneously into a form of energy usable for the road construction machine, but only in accordance with its performance characteristics. However, in road construction machines having a single central power plant, the problem of the correlation between an energy reserve and the resulting remaining operating time of the function system is mitigated by the fact that all functional modules driven directly or indirectly by the single central power plant, in particular by the internal combustion engine, are designed for the rated power output or generally for a reference power output of the single power plant, in particular the internal combustion engine. This makes it possible to ascertain a remaining operating time without difficulty and with sufficient accuracy from the existing quantity of fuel and the knowledge of the performance characteristics of the single power plant of the road construction machine.

Energy management in a road construction machine becomes more complex if the energy supply system comprises multiple energy supply apparatuses, each of which is able to supply energy to the function system, but does so in different ways, in particular at different rates, due to the energy supply apparatuses having different performance characteristics. In particular, though not exclusively, in such cases of a road construction machine having multiple energy supply apparatuses, the present disclosure addresses the need to achieve an efficient, coordinated interaction between multiple, preferably all, energy supply apparatuses of the energy supply system and thus to achieve an efficient operation of the road construction machine.

A further starting point of the present application is the control of a road construction machine having only one energy supply apparatus, for the operation of which, due to energy converters being interposed in the energy supply path from the energy supply apparatus to the first and/or second functional module, boundary conditions no longer apply which otherwise would have applied if the functional module used the form of energy directly output by the energy supply apparatus. If an internal combustion engine outputs mechanical energy, for example, which is normally transmitted via at least one transmission, without conversion of the form of energy, to the work module, for example to a milling unit having a milling drum as a working apparatus, the energy of the internal combustion engine can only be provided while adhering to a working speed required at the work module and/or a working torque of the working apparatus. The specification of a speed and/or a torque at the work module has a direct feedback effect on the energy supply apparatus due to the mechanical coupling between the functional module and the energy supply apparatus. A transmission arranged in the torque path only alters the magnitude of the ratio of the torque and speed between the input side and the output side of the transmission but does not change the fundamental linkage between the speed prevailing at the working apparatus and the speed of the drive shaft of the internal combustion engine.

By interposing one or multiple energy converters, it is possible to eliminate the linkage described above between the speeds and torques of the energy supply system, in particular of a single energy supply apparatus, on the one hand and the first functional module, in particular the work module, on the other hand. If the energy supply system outputs mechanical energy and if this mechanical energy is converted into electrical energy, for example by a generator, and is subsequently again converted into mechanical energy, for example by an electric motor, then, for the purpose of operating the energy supply system, the sole decisive factor becomes the energy demand of the first functional module, specifically the work module, which must be met. Individual operating parameter, such as, for example, speeds and torque of a rotating working apparatus, for example a milling drum, no longer constitute a significant boundary condition for the operation of the energy supply system, in particular of the single energy supply apparatus. An electric motor can be operated in such a wide operating parameter range that its power output matches the operating situation of the rotating working apparatus. To this end, the energy supply apparatus only needs to supply the required drive current or the required drive power.

For the purpose of the present application, a technical apparatus for energy delivery is considered an energy supply apparatus if it is able to deliver energy to the function system independently of the operation of another energy supply apparatus. This is illustrated below with two examples:

In conventional road construction machines having an internal combustion engine as the central power plant, the travel drive often takes the form of a hydraulic drive. The internal combustion engine drives, preferably via a pump transfer gear, at least one hydraulic pump, which generates the hydraulic pressure in a hydraulic circuit for operating the travel drive. In this case, the hydraulic pump is not an energy supply apparatus because its energy output depends directly on the operation of the internal combustion engine. The hydraulic pump in this case is merely an energy converter that converts energy generated by the internal combustion engine from the form of mechanical energy into the different form of hydraulic energy. However, if the hydraulic circuit of the travel drive includes a hydraulic pressure accumulator, the latter can serve as an energy supply apparatus, since the hydraulic pressure accumulator is able to supply energy to the function system at least for a certain period of time even when the internal combustion engine, as the central power plant, is not in operation.

The same applies mutatis mutandis when the internal combustion engine drives an electric generator for generating electrical energy. The energy supply apparatus is then simply the internal combustion engine or the assembly consisting of internal combustion engine and generator, but not the generator alone. However, if the electrical circuit includes a battery as a buffer storage device, then the battery can serve as an energy supply apparatus due to its ability to deliver electrical energy to the function system independently of other energy sources.

According to a preferred embodiment, the control apparatus is designed to control the function system and/or the energy supply system by taking into account, in addition to the availability parameter,
at least one future operating event of the function system and/or of the energy supply system
   and/or
at least one operating state of the function system and/or the energy supply system.

Beyond a mere actual situation, the control apparatus is then able predictively to include a future event in controlling the function system and/or the energy supply system. Such a future event may be, for example, a temporary termination of the work on the work object, for instance because further work is temporarily not possible for reasons of construction site organization or for reasons of necessary maintenance or wear-related repair of the functional system.

The same applies to an operating state. If, for example, the control apparatus knows that after a predicted or known period of time the work on the work object stops temporarily, then the function system and/or the energy supply system may be subjected to greater load for this remaining period of time, for example by accepting a greater heat build-up, than if the work could be continued without interruption.

For an even more precise and better utilization of the amount of energy available on the road construction machine, the control apparatus may be more preferably designed to control the function system and/or the energy supply system by taking into account, in addition to the availability parameter,
a plurality of future operating events of the function system and/or of the energy supply system
   and/or
a plurality of future operating states of the function system and/or of the energy supply system.

Thus, with the knowledge of not only the start, but also the duration or the end of a future operational interruption, the control apparatus can draw upon the deliverable amount of energy and use it to work on the work object in a manner different from how it would proceed if the start and/or the duration and/or the end of the operational interruption were not known. This applies especially when the operational interruption can be used for replenishing at least one energy reserve and/or for regenerating at least one energy supply apparatus of the road construction machine. Normally, replenishing an energy reserve always results in a regeneration of the energy supply apparatus that draws energy from the energy reserve. However, if, for example, a currently unusable mains connection becomes usable at a future point in time, then an energy supply apparatus is thus activated without replenishing an energy reserve for this purpose.

Since it is an objective of the present technical disclosure to ensure the completion of the immediately pending or already begun work task and/or to avoid an undesirable stoppage of the road construction machine or its work module, the control apparatus, according to a preferred embodiment of the present disclosure, is designed to control the function system and/or the energy supply system on the basis of at least one piece of remaining time information, wherein the at least one piece of remaining time information represents a remaining operating time of the work module.

In this context, remaining time information may manifest in one, several, or all of at least three different aspects and be processed by the control apparatus, namely, as remaining time potential, as remaining time requirement and as remaining time quota.

A remaining time potential is remaining time information that represents a future time period over which the function system can be operated in accordance with the availability parameter in a given and/or assumed and/or predicted operating situation.

A remaining time requirement is remaining time information that represents a future time period that is required under specified and/or assumed and/or predicted operating parameters of the function system in order to complete a current or an imminently upcoming work task.

A remaining time quota is remaining time information that indicates until when or for how long the function system can or normally should be operated before the operation ends, at least temporarily, for reasons not directly related to the availability parameter. Such reasons may be, for example, of a legal or organizational or technical nature. The aforementioned knowledge of a future interruption of operation or a future end of operation is an example of remaining time information in the form of a remaining time quota. It indicates how long the function system is theoretically usable.

Legal and/or organizational reasons for a future interruption of operation such as operational breaks, shift schedules, prohibition of night work, for example, may be quite independent of the availability parameter. Technical reasons for a future interruption of operation such as wear-related maintenance, for example, may depend indirectly on the availability parameter, for example if, on the basis of the availability parameter, operating parameters of the function system are set so as to reduce an initially prevailing rate of wear. However, there is no direct connection to the availability parameter.

In contrast to the remaining time potential, for the ascertainment of which a defined, available amount of energy-typically zero or a predetermined safety reserve—plays a role, the amount of energy still available at the time of the occurrence of an event that ends the operation of the function system and establishes the remaining time quota plays no role in ascertaining a remaining time quota.

The starting point for determining the remaining time requirement is the work task to be performed, that is, for example the amount of ground to be removed, the ground parameters characterizing the ground material such as the composition and/or grain size and/or density and/or hardness. Further determining factors for completing the characterized work task are the earth working tool used, operating parameters of the function system, such as rotational speed and forward motion speed of a removal apparatus, as well as further conditions of the construction site such as whether the ground volume to be removed is to be removed in a single pass of shallow removal depth or in several short passes of greater removal depth. Some of the influencing parameters affecting the remaining time requirement are fundamentally independent of the available amount of energy. Other influencing parameters affecting the remaining time requirement, such as operating parameters of the function system for example, are interdependent with the available amount of energy in that their value affects the energy consumption of the road construction machine and that they thereby influence the available amount of energy and thus the availability parameter. Hence, the present control of the function system and/or of the energy supply system based on the availability parameter typically also has a feedback effect on the influencing parameters and thus on the remaining time requirement.

The control apparatus is preferably also designed to ascertain at least a portion of the at least one piece of remaining time information.

The control apparatus may be designed to ascertain at least a portion of the at least one piece of remaining time information from at least one time information parameter, wherein the at least one time information parameter comprises at least one of the following parameters and/or is ascertained on the basis of at least one of the following parameters:
at least one function parameter of the function system,
at least one operating parameter of the function system,
at least one energy parameter of the energy supply system,
at least one work parameter of a work task currently performed and/or to be performed in the future,
at least one construction site parameter.

At least some of the mentioned parameters are, in the present context, time information parameters, since they influence the duration or contain information about the duration over which the available amount of energy is sufficient for operation under given operating conditions. These time information parameters are primarily or exclusively used to ascertain a remaining time potential.

At least some of the mentioned parameters are, in the present context, time information parameters, since they influence the duration or contain information about the duration required for completing a current or imminently upcoming work task. These time information parameters are primarily or exclusively used to ascertain a remaining time requirement.

At least some of the mentioned parameters are, in the present context, time information parameters, since they contain information about the remaining duration of use of the road construction machine during which the road construction machine can be operated. These time information parameters are primarily or exclusively used to ascertain a remaining time quota.

The work task to be performed may be part of a work assignment comprising several work tasks. It may be a complete work task that has not yet been started. The work task may already have been started, in which case the duration refers only to the remaining portion of the work task that has not yet been completed.

Since the primary task of the road construction machine is to work on the work object, such as a section of the ground for example, and the self-propelled ground-based movement of the road construction machine is by contrast only a supporting function for completing the primary task, and since moreover the operation of the function system, in particular of the working module, during an earth work operation, has the highest energy consumption per unit of time, a possible end of a work task is a point in time or an event when the working module has the scheduled opportunity to transition from a state of working on the work object to an idling state or a standstill. With the transition to the idling state or the standstill, first, a significantly lower amount of energy is required for the further operation of the road construction machine and, second, there may be an opportunity for replenishing energy reserves such that the availability parameter may change in magnitude after the transition of the work module into an idling state or a standstill. In other words: the predictive reliability of the availability parameter currently ascertained by the control apparatus typically extends only up to the scheduled idle state or standstill.

The work task preferably ends when, in addition to the opportunity of the working module to transition to the idle state of standstill, there is the further opportunity to increase the available amount of energy, that is, to tap into new energy supply apparatuses or to regenerate existing energy supply apparatuses.

Tapping into new energy supply apparatuses may mean, for example, reaching a location on the construction site, where it is possible to establish an electrical mains connection of the road construction machine, whereas prior to reaching this location such a connection option is too far away and thus does not exist. An existing energy supply apparatus may be regenerated, for example, by charging at least one energy store, including filling fuel tanks, or replacing at least one energy store in a more discharged state with an energy store in a more charged state.

The at least one function parameter represents at least one power consumption value of at least one functional module, in particular at least of the working module. The power consumption may be a current power consumption during current work on a work object or may be a power consumption during work on a work object immediately prior to current work or prior to current work within a predetermined time span. The power consumption may be an, in particular arithmetic or geometric, average value, which was ascertained over a past work period. The power consumption may be a sum of individual power consumptions of different functional modules, wherein the statements made above about power consumption apply to each individual power consumption.

Depending on the design of the respective functional module, its power consumption may be ascertained very precisely. If a functional module is directly connected to an electric drive, then the power consumption of the electric drive, and thus of the functional module connected to the electric drive, can be ascertained directly from the voltage drop across the electric drive and the current flowing through the electric drive. In the case of a working module driven directly by an internal combustion engine, its power consumption may be ascertained from the fuel mass flow into the internal combustion engine and the mass-specific calorific value of the fuel, optionally taking into account the efficiency factor of the internal combustion engine. It is thereby possible to ascertain the power consumption very precisely retrospectively or at the current work time. As long as the circumstances of the work on the work object do not change or change only negligibly, the known power consumption values of the past may be used to extrapolate in forecasting for an essentially identical future work task.

The control apparatus can treat the function parameter as a parameter representing a future power consumption, in particular a future power consumption per unit of time, so that on the basis of the function parameter and of the availability parameter the control apparatus can ascertain an achievable remaining work duration.

The at least one operating parameter of the function system, that is, of at least one functional module of the same, preferably of the energy consumption-intensive working module, typically influences the power consumption of the function system or of the at least one functional module and thus the function parameters and also the duration of the work task until its completion. The operating parameters of the function system are the parameters modifiable or settable by the control apparatus for controlling the function system.

Since the road construction machine has as its most energy-intensive task the work on the work object, such as for example a section of the ground, the working module is typically the greatest energy and power consumer when it is in earth working operation. In the preferred case, in which a removal apparatus rotatable about a rotational axis is a key component of the work module, the operating parameters that influence the time required until a work task is completed include a rotational speed of the removal apparatus about the rotational axis and a depth of engagement of the removal apparatus into the work object. Another operating parameter of the function system, typically the drive system, that is important for earth work is the forward motion speed of the removal apparatus crosswise to the axis of rotation. These operating parameters influence the function parameters of the functional module and in particular of the work module as the most energy consumption-intensive component of the function system.

The at least one energy parameter represents at least one state parameter and/or at least one operating parameter of at least one energy supply apparatus. The state parameter of the at least one energy supply apparatus is preferably a parameter that is recorded as recently as possible, which indicates at least one state of the at least one energy supply apparatus, for example a change in the efficiency factor due to aging of the at least one energy supply apparatus, a temperature of the at least one energy supply apparatus that influences its energy output, a basic operational readiness of the at least one energy supply apparatus, etc.

Although a state of charge of a battery, a fill level of a tank and the like also represent states of the energy supply apparatus, the available energy reserve is already accounted for by the availability parameter.

The statements made above about the at least one operating parameter of the function system, also apply mutatis mutandis to the at least one operating parameter of the at least one energy supply apparatus. The operating parameter may preferably be a current operating parameter of the at least one energy supply apparatus. The operating parameter may be an average value of an operating parameter ascertained over a certain operating period, for example in order to smooth out temporal fluctuations of the operating parameter.

An operating parameter may be, for example, a current temporal energy output rate of an energy supply apparatus and the like.

The energy parameter can thus contribute toward ascertaining the availability parameter.

The at least one work parameter preferably represents information about a current and/or future work task that is yet to be performed. The resource expenditure estimation known from DE 10 2021 133 306 A1 can be used for this purpose. The at least one work parameter may also take into account information about the material to be processed, such as for example its hardness, granularity, abrasiveness, etc. ; a possible structure, in particular layer structure of the work object and the like, to mention only a few examples.

Examples of work parameters that are more strongly determined by the structural design of a work module for ground-removing work on a work object are inter alia the following: a type of the removal apparatus used; a physical size of the removal apparatus such as a milling width in the case of a milling drum as a removal apparatus; a state, for example a state of wear, of the removal apparatus; a type of a removal tool used on the removal apparatus; a number of removal tools, for example milling bits, on the removal apparatus; an arrangement of the removal tools, for example a linear spacing of milling tools, on the removal apparatus, etc. The work parameters mentioned in the preceding non-exhaustive list characterize the work module in its properties relevant for the work task with regard to an energy consumption regardless of the respective operating modes selected.

In addition, the energy requirement of the at least one functional module is determined by currently prevailing operating parameters of the function system. Examples of operating parameter that are more strongly determined by the current operation of the work module for ground-removing work on the work object are a rotational speed of the working apparatus during a removal process, a depth of engagement during a removal process, a forward motion speed during a removal process, a torque of the working apparatus, and the like.

On the basis of the work parameter, the control apparatus is able to ascertain at least an estimated value of how much energy is required for continuing the currently performed or imminently upcoming work task up to a relevant milestone of this work task. The control apparatus is thus able to ascertain with sufficient predictive accuracy how long an available amount of energy will suffice for the remaining work activities, i.e., to ascertain the remaining time potential. Knowing the at least one work parameter, the control apparatus is able to project the function parameter into the future with good predictive accuracy, for example because, based on the at least one work parameter, the control apparatus is able to extrapolate e.g. the current function parameter with sufficient precision into the future, or to predict operating parameter to be set in the future.

The mentioned milestone of a work task may be the end of the work task.

The at least one construction site parameter represents preferably information about the structure and/or organization of the construction site, on which the road construction machine is deployed to perform the respective work task. The construction site parameter-which in terms of construction site structure takes into account the maneuvering paths to be traveled on the construction site and/or the complexity of the work task, and/or which in terms of construction organization takes into account the availability of peripheral machines cooperating with the road construction machine, such as the availability of transport capacities for removing rubble produced by the road construction machine-makes it possible on the basis of the structure and/or organization of the construction site to take into account an increased or reduced resource expenditure in the performance of a work task known per se. The construction site parameter may be a factor, for example, by which the at least one work parameter is multiplied.

The construction site parameter may contain information about the prescribed break and shift schedules, about maintenance options in terms of scope, location and time and the like. The construction site parameter may thus also be used to determine remaining time information, in particular a remaining time quota.

According to the foregoing explanations, an expedient way for the control apparatus to control the function system and/or the energy supply system on the basis of at least one availability parameter, while taking into account remaining time information, is to ascertain a remaining time potential of the function system and/or the energy supply system on the basis of the at least one availability parameter and, if necessary, to modify at least one operating parameter of the function system and/or the energy supply system in such a way that the remaining time potential is not smaller, preferably greater by at least one safety margin to be selected or predetermined, than a remaining time quota known to or ascertained by the control apparatus and/or a remaining time requirement ascertained by the control apparatus.

Accordingly, in accordance with a preferred embodiment of the present disclosure, the control apparatus is designed to control the function system and/or the energy supply system in accordance with the availability parameter in that the control apparatus controls the function system and/or the energy supply system in accordance with a comparison between a remaining time potential and a remaining time requirement and/or a remaining time quota. The control apparatus is in particular designed to control the function system and/or the energy supply system in accordance with the comparison in such a way that the remaining time potential is not smaller, and preferably greater, than the remaining time requirement and/or the remaining time quota.

For an advantageously precise and efficient utilization of the available quantity of energy, the control apparatus, in a preferred embodiment of the present disclosure, is designed to control the function system and/or the energy supply system while taking into account at least one regeneration parameter, wherein the at least one regeneration parameter represents a quantity of energy that can be fed into the energy supply system. For this purpose, it is particularly advantageous if the control apparatus has access to data that indicate the start and end or the start and duration or end and duration of a future operating phase of the road construction machine, in particular an interruption of the operation of the function system that can be used for a procurement of energy.

The control apparatus may be designed to ascertain the regeneration parameter from at least one of the following parameters: from an available regeneration duration, from a quantity of energy that can be fed into the respective energy supply apparatus per unit of time, from a total quantity of energy available for the regeneration, and from a conversion efficiency with which a quantity of energy available at the road construction machine in a form of energy into a form of energy that can be utilized for the energy supply apparatus to be regenerated.

Thus, for example, in a period available for regeneration, it is possible to convert fossil fuel or fuel of a fuel cell into electrical energy by operating a generator or by operating a fuel cell and to store this electrical energy in a battery.

Additionally or alternatively, the control apparatus may be designed to control the function system and/or the energy supply system on the basis of remaining energy requirement information, wherein the remaining energy requirement information represents a remaining energy requirement of the road construction machine for completing a work task or reaching a determinable or predetermined milestone of a work task.

While the remaining time potential basically represents a conversion of the availability parameter from the unit of energy to the unit of time by taking into account current and/or planned operating parameters, and in this way can be compared with an orientation or target parameter likewise expressed in the unit of time, such as for example the remaining time requirement and/or remaining time quota, the use of remaining energy requirement information allows for a direct comparison with the availability parameter.

Whether a control operation is performed in the unit ‘time’ or in the unit ‘energy’ or in both units depends on the individual case of the respective work task and its accompanying circumstances. If, for example, operating parameters can only be predicted with a high degree of uncertainty due to incomplete data about the work task, or if time constraints play no role or only a minor role in the completion of the work task, control based directly on energy variables such as availability parameters and remaining energy requirements, may be appropriate. If the opposite is the case, control based on time parameters may be preferable. As a plausibility check, both calculation methods may be used and their results compared with one another.

The control apparatus is preferably designed to ascertain the remaining energy requirement information. At an abstract level, the same parameters of the control apparatus may be used to ascertain the remaining energy requirement information that are also used to ascertain the remaining time information in the form of the remaining time requirement. Individual concrete physical variables, which can be respectively subsumed as function parameters or as operating parameters of the function system or as energy parameters or as work parameters or as construction site parameters, may differ for ascertaining the remaining time requirement on the one hand and the remaining energy requirement on the other hand. Furthermore, while in principle the same parameters may be used for ascertaining the remaining time requirement on the one hand and the remaining energy requirement on the other hand, they are weighted differently. Thus, for ascertaining the remaining energy requirement, greater emphasis may be placed on the at least one energy parameter, while for ascertaining the remaining time requirement, greater emphasis is placed on the at least one work parameter.

Based on the statements made above, the control apparatus is preferably designed to ascertain the remaining energy requirement information from at least one energy requirement parameter, wherein the at least one energy requirement parameter comprises at least one of the following parameters:
at least one function parameter of the function system,
at least one operating parameter of the function system,
at least one energy parameter of the energy supply system,
at least one work parameter of a work task currently performed and/or to be performed in the future,
at least one construction site parameter.

With regard to the individual parameters of function parameters, operating parameters of the function system, energy parameters, work parameters and construction site parameters, the statements made above in explaining the ascertainment of the remaining time information also apply to the ascertainment of the remaining energy requirement information.

According to the explanations provided above, an additional or alternative expedient way for the control apparatus to control the function system and/or the energy supply system on the basis of at least one availability parameter, while taking into account remaining energy requirement information, is to change at least one operating parameter of the function system and/or of the energy supply system on the basis of the at least one availability parameter in such a way that the available quantity of energy deliverable to the function system is not smaller, and preferably greater by at least one safety margin that is to be selected or that is predetermined, than the remaining energy requirement known to or ascertained by the control apparatus up to the completion of a work task or up to reaching a milestone of the same.

There are generally always competing objectives in the completion of a work task, such as for example completing it as quickly as possible, on the one hand, and completing it in a manner that conserves resources as much as possible, in terms of energy efficiency. The achievement of one objective is always at the expense of the other objective. The design of the control apparatus described herein to control the function system and/or the energy supply system on the basis of at least one availability parameter, allows the control apparatus, in a preferred aspect of the disclosure, to modify the operating setting of the function system with regard to the duration of the work until the completion of the work task and the quantity of energy expended for this purpose during the work in favor of one or the other objective in order reliably to reach a milestone of the work task with as high a degree of productivity as possible, for example without an unwanted standstill of the road construction machine and/or of the infrastructure cooperating with it.

As already explained at the outset, the present disclosure is particularly effective when multiple energy supply apparatuses are provided on the road construction machine, each of which is designed to deliver energy to the function system for its operation. Hence, a preferred embodiment of the present disclosure relates to the case where the function system requires energy in a predetermined form, wherein the energy supply system as a plurality of energy supply apparatuses comprises either
a) a plurality of different energy stores, each of which provides energy in the predetermined form, or
b) a plurality of different energy converters, which, respectively on the basis of different physical principles, convert energy provided in a form differing from the predetermined form of energy into the predetermined form, or
c) at least one energy store according to a) and at least one energy converter according to b).

In this connection, an electrical mains supply is regarded as an energy store within the scope of the present disclosure. From the perspective of the road construction machine and its control apparatus, a mains supply is a store for electrical energy with a virtually infinite capacity, which, however, like any other electrical energy store, is able to deliver electrical energy to the road construction machine and thus to the function system only in finite quantities per unit of time. For this reason, even a mains connection, under certain circumstances, may not be able fully to cover a required short-term peak load in spite of its virtually infinite capacity.

The expression “virtually infinite capacity” is meant to convey the fact that, while even the capacity of a mains connection is in reality, of course, only of a finite magnitude, the limit of this capacity of electrical charge cannot be reached in practice for the purposes of the road construction machine presently discussed. However, there may be technical or contractual restrictions limiting the amount of electrical energy that can be drawn from a mains connection in a predetermined time to a predetermined limited amount so as not to overload electrical lines of the road construction machine and/or the supplying public grid.

In the case of an array of multiple energy supply apparatuses, in particular multiple energy supply apparatuses for providing the predetermined form of energy, it is advantageous if the at least one availability parameter for each energy supply apparatus of at least two energy supply apparatuses of the plurality of energy supply apparatuses respectively comprises an apparatus-specific availability parameter representing the amount of energy available from the respective energy supply apparatus. The statements made above about the availability parameter also apply to the apparatus-specific availability parameter.

The apparatus-specific availability parameter makes it possible to distinguish the individual energy supply apparatuses from the plurality of energy supply apparatuses with regard to their energy delivery capacity and, by taking into account their energy delivery capacity, include them in control decisions about the delivery of energy to the function system.

The control apparatus is preferably designed to control the function system and/or the energy supply system on the basis of the apparatus-specific availability parameters. This allows for a more differentiated control of the function system and/or the energy supply system according to different energy supply apparatuses and consequently for an improved energy management and thus for an even better utilization of the energy quantities available at individual energy supply apparatuses.

In order to control the road construction machine in accordance with the availability parameter and thus in accordance with the available amount of energy, whether as a cumulative sum of quantities of energy and/or as individual available quantities of energy of different energy supply apparatuses of the energy supply system, and thereby to ensure that the available amount of energy, if applicable, in an available remaining operating time, is delivered to the function system in an effective and efficient manner, the control apparatus may be designed to limit a power consumption of at least one functional module and/or an energy output of at least one energy supply apparatus in terms of quantity.

Thus, as already generally explained above, the control apparatus can ensure, for example, that the road construction machine, by utilizing the remaining time potential, remains usable up to a predetermined time at which an operational break must be taken anyway, for example because tools of the work module must be inspected, replaced or repaired, or because machines of the construction site cooperating with the road construction machine, such as transport vehicles and the like, are available only up to the predetermined time and a further operation of the road construction machine is not possible without the cooperating machines, or because operating materials that are not energy sources of the energy supply system, such as water for example, must be replenished in the road construction machine, or because the machine operator must take a break prescribed for safety reasons. In this manner, it is possible to avoid a premature stoppage of the road construction machine due to a lack of operating energy. It is thus possible to adhere to the construction site schedule, on which further machine deployments beyond the road construction machine depend.

Thus, the control apparatus can reduce the power consumption and thereby the working output of the work module or another functional module in order to be able to use the available amount of energy over a longer period than without this reduction, until at least one energy supply apparatus can be tapped or regenerated according to schedule. Additionally or alternatively, the control apparatus may reduce an energy delivery of at least one energy supply apparatus to the function system to achieve the same effect.

In addition or as an alternative to the reduction of the amount of energy usable by the function system described above, the control apparatus may be designed to combine an output of energy in the predetermined form from a plurality of energy supply apparatuses. The control apparatus is thus able to supply one or multiple functional modules of the function system with the energy in the predetermined form from more than one energy supply apparatus in order to ensure the completion of a work task by a specified deadline, provided that the amount of energy in the predetermined form available in the energy supply system is sufficient, if applicable, by taking into account further boundary conditions such as, for example, a regenerative capability, for completing this task.

The predetermined form of energy is preferably electrical energy, which can be stored by various energy stores and supplied by various energy converters. Energy stores for providing electrical energy may be at least one battery or a mains connection. Energy converters for providing electrical energy may be at least one fuel cell or at least one generator driven by a drive unit.

In the present application, the term “battery” refers to a rechargeable battery, as is customary for vehicles. The term “fuel cell” refers to at least one fuel cell or at least one fuel cell stack.

The energy supply system therefore comprises preferably at least two of the following energy supply apparatuses:
a battery,
a mains connection,
a fuel cell,
a generator.

Normally, every self-propelled road construction machine, and thus its energy supply system, comprises a rechargeable battery as an energy supply apparatus, regardless of the drive type of its travel drive.

The energy supply system of the road construction machine preferably comprises at least one of the following further energy supply apparatuses to ensure its supply with a sufficient amount of electrical energy:
a fuel cell,
a mains connection,
a generator.

The at least one further energy supply apparatus is preferably designed not only to deliver energy to the function system but also to deliver energy to the rechargeable battery. The battery can thus be recharged by on-board energy supply apparatuses.

So as not to expand the space requirement of the road construction machine excessively, the energy supply system, taking into account the likewise present function system, is preferably designed in such a way that the maximum load to be expected in a work task of the function system and/or the maximum power the function system is able to output for a short period can only be achieved by the simultaneous energy output of at least two energy supply apparatuses of the energy supply system. In other words: the maximum deliverable power of each energy supply apparatus is less than the maximum rated power output the function system can deliver for a short period. In this configuration in particular, it makes sense to convert an existing non-electrical form of energy into electrical energy for regenerating the battery in order to ensure that the function system, following the regeneration of the battery, can draw not only an average continuous rated power but also a short-term maximum rated power exceeding the average continuous rated power, in particular significantly exceeding the average continuous rated power by at least 30%.

Furthermore, an energy supply apparatus, in particular a fuel cell, can preferably deliver power at an advantageous operating point under continuous load that remains essentially constant over time. As a continuous load operating point, the operating point may be in the range of a maximum energy efficiency, for example in the range of a maximum efficiency factor. With respect to the power deliverable by the energy supply apparatus at the advantageous operating point, the range may start at 80%, optionally at 85%, of the power deliverable at the advantageous operating point and end at 120%, optionally at 115%, of the power deliverable at the advantageous operating point. The power deliverable in this advantageous power output range may be less than the power required for the work on the work object for at least 40% of the duration of the work on the work object, so that two energy supply apparatuses are required for at least 40% of the duration of the work on the work object in order to provide the power required for the work on the work object.

The control apparatus is preferably designed to control the delivery of energy by the at least one further energy supply apparatus to the rechargeable battery in order to charge the rechargeable battery. In this way, based on the availability parameter, optionally taking into account the at least one piece of remaining time information, in particular the remaining time potential, and/or remaining energy requirement information, the control apparatus is able to supply electrical energy of the at least one further energy supply apparatus either to the function system or to the battery or, if indicated, to both the function system and the battery in a distribution ratio ascertained by the control apparatus.

In principle, the road construction machine may be any road construction machine. In the present context, the road construction machine is preferably a material-removing road construction machine, such that the work module preferably comprises a milling drum rotatable about a milling axis. The road construction machine may therefore be a road milling machine or a surface miner or a recycler or a stabilizer.

The present disclosure will be explained in greater detail below with reference to the enclosed drawings. The figures show:

### BRIEF DESCRIPTION OF THE DRAWINGS

FIG. 1 a rough schematic lateral view of an embodiment of a self-propelled road construction machine according to the disclosure,

FIG. 2 a characteristic curve of the fuel cell in the road construction machine of FIG. 1, which shows in rough schematic fashion the efficiency factor of the fuel cell as a function of its power output,

FIG. 3 a diagram showing in rough schematic fashion the power output of the energy supply apparatus of the road construction machine of FIG. 1 during regular earth work by a road construction machine of FIG. 1 having a conventional control apparatus, from the start of the earth work to a current point in time,

FIG. 4 a diagram showing in rough schematic fashion the state of charge of the accumulator and the remaining fuel supply for operating the fuel cell of the road construction machine having a conventional control apparatus of FIG. 1 in the course of the earth work,

FIG. 5a a diagram showing in rough schematic fashion the power output of the energy supply apparatus of the road construction machine of FIG. 1 during the same regular earth work by a road construction machine of FIG. 1 having a control apparatus designed in accordance with the disclosure, which modifies the control of the energy supply system, from the start of the earth work to the current point in time,

FIG. 5b an alternative diagram showing in rough schematic fashion the power output of the energy supply apparatus of the road construction machine of FIG. 1 during the same regular earth work by a road construction machine of FIG. 1 having a control apparatus designed in accordance with the disclosure, which modifies the control of the function system, from the start of the earth work to the current point in time,

FIG. 6a a diagram showing in rough schematic fashion the state of charge of the accumulator and the remaining fuel supply for operating the fuel cell of the road construction machine having a control apparatus designed according to the disclosure, in accordance with the control intervention of FIG. 5a in the course of the earth work,

FIG. 6b a diagram showing in rough schematic fashion the state of charge of the accumulator and the remaining fuel supply for operating the fuel cell of the road construction machine having a control apparatus designed according to the disclosure, in accordance with the control intervention of FIG. 5b in the course of the earth work,

FIG. 7 a diagram showing in rough schematic fashion the characteristic curve of the power output of the energy supply apparatus of the road construction machine of FIG. 1 during the entire regular earth work by a road construction machine of FIG. 1 having a control apparatus designed according to the disclosure, in accordance with the control intervention of FIG. 5a, and

FIG. 8 a diagram showing in rough schematic fashion the characteristic curve of the state of charge of the accumulator and the characteristic curve of the fuel supply for operating the fuel cell of the road construction machine having a control apparatus designed according to the disclosure of FIG. 1 for the entire regular earth work, in accordance with the control intervention of FIG. 5a,

The figures are not to scale.

### DETAILED DESCRIPTION

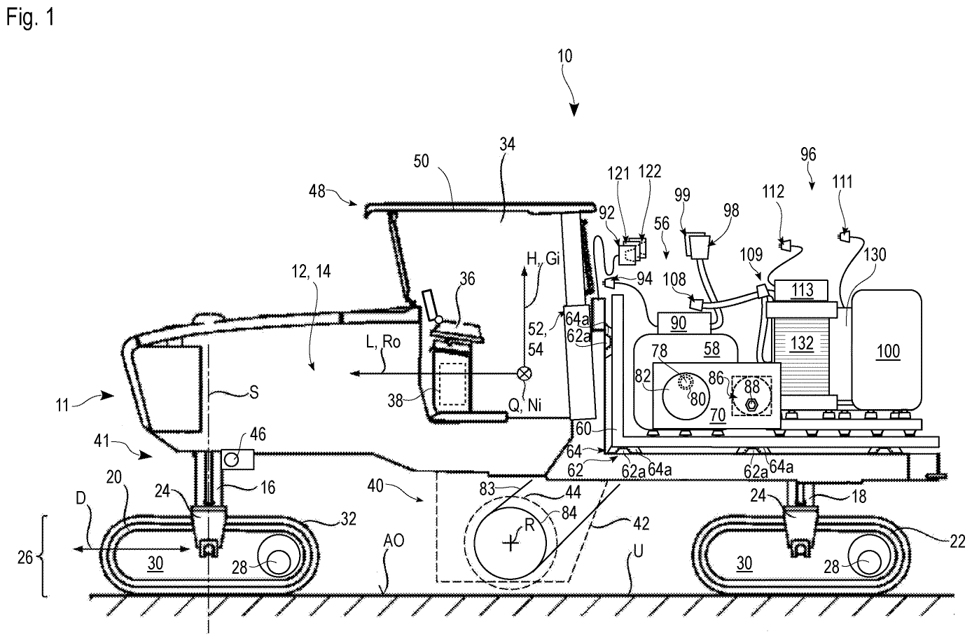

The viewer of FIG. 1 is looking at an earth working machine or road construction machine 10, or simply “machine” 10, in the direction of the transverse machine direction Q, which is orthogonal to the drawing plane of FIG. 1. A longitudinal machine direction orthogonal to transverse machine direction Q is labeled L and extends parallel to the drawing plane of FIG. 1. A vertical machine direction H likewise extends parallel to the drawing plane of FIG. 1 and orthogonally to longitudinal machine direction L and to transverse machine direction Q. The arrowhead of longitudinal machine direction L in FIG. 1 points in the forward direction. Vertical machine direction H extends parallel to the yaw axis Gi of machine 10, longitudinal machine direction L extends parallel to the roll axis Ro, and transverse machine direction Q extends parallel to pitch axis Ni.

The self-propelled road construction machine 10 comprises a base road construction machine 11 as a machine basis.

The base road construction machine 11 comprises a machine frame 12, which forms the basic framework for a machine body 14. The machine body 14 comprises the machine frame 12 and components of machine 10 and of the base road construction machine 11 which are connected to the machine frame 12 and which are possibly movable relative thereto.

The machine body 14, the number of components of which grows during the assembly of the self-propelled road construction machine 10, comprises front hydraulic lifting columns 16 and rear hydraulic lifting columns 18 on the base road construction machine 11, which are connected in their one end region, for example by a cylinder, to the machine frame 12 and with their other end region, for example by a piston rod extending out of and retracting into the cylinder, to front drive units 20 and to rear drive units 22.

It is not apparent in the lateral view of FIG. 1 that machine 10 comprises both in its front end region as well as in its rear end region respectively two lifting columns 16 and 18, each having a drive unit 20 and 22, respectively, connected to it. The front lifting columns 16 and the rear lifting columns 18 are respectively coupled to drive units 20 and 22, in a manner also known per se, by a drive unit connecting structure 24, for example a connecting fork fitting over the respective drive unit 20 and 22 in transverse machine direction Q.

The drive units 20 and 22 are depicted by way of example as crawler track units. In the illustrated exemplary embodiment, they are constructed essentially identically and form the traveling gear 26 of machine 10 as well as of the base road construction machine 11. In a departure therefrom, individual, or all, drive units 20 and/or 22 may also be wheel drive units. Each of the drive units 20 and 22 is motor-driven, in the illustrated exemplary embodiment by a hydraulic motor 28.

In the illustrated exemplary embodiment, the drive unit 20 and the drive unit 22, their possible travel directions indicated by double arrow D, respectively have a radially inner accommodation and guidance structure 30 on which a revolving drive track 32 (labeled only on front drive unit 20) is arranged and is guided to perform a revolving movement. The inner guidance structure is connected to the drive unit connecting structure 24 so as to be tiltable about a tilting axis parallel to the pitch axis Ni.

The distance of the machine frame 12 from drive units 20 and 22 and from a contact surface AO of the ground U, on which the machine 10 stands with its traveling gear 26, is variable by way of the hydraulic lifting columns 16 and 18.

The road construction machine 10 or base road construction machine 11 comprises an operator platform 34, from which a machine operator is able to operate machine 10 in controlling fashion via a control panel 36 with a control unit 38 accommodated therein. The control unit 38 may also be referred to as a controller 38.

A working apparatus 40 as a functional module of a function system 41 is situated below the machine frame 12, in this case by way of example as a milling apparatus 40 having a milling drum 44 accommodated in a milling drum housing 42 as a working tool of the working apparatus 40. The milling drum 44 is rotatable about a milling axis R extending in the transverse machine direction Q so that ground material may be removed therewith during an earth working operation, starting from the contact surface AO of the ground U to a milling depth determined by the relative vertical position of the machine frame 12 above the contact surface AO. The vertical adjustability of machine frame 12 by way of lifting columns 16 and 18 consequently also serves to set the milling depth, or generally the engagement or working depth, of machine 10 in earth working operation. Alternatively or additionally, the milling drum 44 may be accommodated on the machine frame 12 so as to be vertically adjustable relative to the machine frame 12.

For the large road milling machine illustrated in FIG. 1, the arrangement of the milling apparatus 40 between the front and rear drive units 20 and 22 in longitudinal machine direction L is typical. Large milling machines of this kind and earth-removing machines in general may comprise a transport belt, for example at the front longitudinal end in the region of reference numeral 11, to transport removed ground material away from the machine 10. In the interest of better clarity, a transport belt that is in principle also present in the case of machine 10 is not depicted in FIG. 1.

Lifting column 16, and with it drive unit 20, is rotatable about a steering axis S by way of a hydraulic steering apparatus 46 indicated only in rough schematic fashion. Preferably additionally, but also alternatively, the rear lifting column 18, and with it drive unit 22, may be rotatable by way of a steering apparatus about a steering axis parallel to steering axis S.

The operator platform 34 is covered by a protective canopy structure 48, which comprises a protective canopy 50. The protective canopy 50 is arranged on the machine frame 12 so that it can be raised and lowered by a movement guide 52 and a hydraulic movement drive 54. In FIG. 1, the protective canopy 50 is shown in its raised operating position, in which the machine 10 is ready for earth working operation.

The hydraulic motors 28, the control unit 38, the hydraulic steering apparatus 46, the lifting columns 16 and 18 and the hydraulic movement drive 54 of the protective canopy structure 48 are respectively further functional modules of function system 41.

To form the road construction machine 10, a power system 56 as a central power plant of machine 10 is situated on the base road construction machine 11. The power system 56 essentially provides the entire working output of the machine 10.

The power system 56 comprises an electric motor 58 as a power apparatus and comprises a support device 60 for connecting the power system 56 as an exchangeable module to the base road construction machine 11.

An output shaft 78 of the electric motor 58 forms a working energy counterpart interface of the electric motor 58 and thus of the power system 56. The output shaft 78 is connected in torque-transmitting fashion to an input hub 80 of a pump transfer gear 70.

The pump transfer gear 70 has as a mechanical power take-off a belt pulley 82, which may be completed by a drive belt 83, merely indicated in FIG. 1, with a belt pulley 84 coupled in torque-transmitting fashion to the milling drum 44 as a working energy interface to form a belt drive. Depending on requirements, a speed-increasing gear, a speed-reducing gear or no further gear may be arranged between the belt pulley 84 on the side of the milling drum and the milling drum 44. Since the belt pulley 82 on the gearing side transmits the working energy required for the work of the milling apparatus 40, the gearing-side belt pulley 82 forms the main power take-off of the pump transfer gear 70.

As an alternative to the milling drum drive via a belt drive, the milling drum may also be driven directly by one or multiple electric motors. Alternatively or additionally, a separate electric motor may also be provided for driving the hydraulic pumps situated in the pump transfer gear.

On a further power take-off, more precisely on an ancillary power take-off of the pump transfer gear 70, a hydraulic pump 86 is arranged, which in its operation outputs pressurized hydraulic fluid as fluidic working energy on a quick coupling 88 as a coupling formation. The fluidic working energy of the hydraulic pump 86 may be used by the hydraulic motors 28 for propelling the road construction machine 10 and/or by the hydraulic movement drive 54 of the protective canopy structure 48 for raising and lowering the protective canopy 50 and/or by the steering apparatus 46 for a steering actuation of the front lifting columns 16 and/or of the rear lifting columns 18. The hydraulic pump 86 is able to pressurize a quantity of hydraulic fluid present on the road construction machine 10 via the quick coupling formation 88.

In the illustrated embodiment example, the electric motor 58 has its own motor control unit 90, which in operation forms a component control unit subordinate to the control unit 38. For connecting the motor control unit 90 to the control unit 38 of the base road construction machine 11 or the road construction machine 10, the base road construction machine 11 has a first signal interface 92, with which a first signal counterpart interface 94 of the electric motor 58 may be coupled in data and signal-transmitting fashion. One interface of the first signal interface 92 and the first signal counterpart interface 94 may comprise a plug and the respective other interface may comprise a fitting socket.

As an electrical power system 56, the power system 56 requires operating energy in electrical form. For this purpose, an energy supply system 96 is provided, which inter alia has an accumulator 130 as an energy store. Electrical cables connect the electric motor 58 to the accumulator 130 for transmitting energy when an operating energy interface 98 of the electric motor 58 is connected to an operating energy counterpart interface 108 of the accumulator 130. To facilitate a simple, secure and quick establishment of an energy transmission line between the accumulator 130 and the electric motor 58, the operating energy interface 98 and the operating energy counterpart interface 108 are designed as electrical quick coupling components, for example as plug and socket. The accumulator 130 is part of a module that is connected in exchangeable fashion to the base road construction machine 11.

The power system 56 and the energy supply system 96 complete the base road construction machine 11 to form the road construction machine 10.

In the illustrated embodiment example, the accumulator 130 has an integrated control unit, not specifically shown in FIG. 1, which is connectible to the control unit 38 on the base road construction machine 11 by way of a second signal counterpart interface 111 using a second signal interface 121 on the side of the base road construction machine 11 for transmitting signals and data. In the operation of the road construction machine 10, the control unit of the accumulator 130 also forms a component control unit of road construction machine 10 that is subordinate to control unit 38.

In addition to the electrical accumulator 130, a further module having a fuel cell 132 and a fuel tank 100 connected to the fuel cell 132 is provided in the energy supply system 96. The fuel cell 132 converts the fuel stored in the fuel tank 100 into electrical energy. A control unit 113 controlling the operation of the fuel cell 132 is connectible to the control unit 38 on the base road construction machine 11 by way of a third signal counterpart interface 112 using a third signal interface 122 on the side of the base road construction machine 11 for transmitting signals and data. The third signal interface 122 may be designed like the first signal interface 92 and/or the second signal interface 121. In the operation of the road construction machine 10, the control unit 113 also forms a component control unit of road construction machine 10 that is subordinate to control unit 38.

For the energy-transmitting coupling of the electric motor 58 to the fuel cell 132, a further operating energy interface 99 of the electric motor 58 and an operating energy counterpart interface 109 of the fuel cell 132 are designed as electrical quick coupling components, for example as plug and socket. Electrical cables connect the electric motor 58 to the fuel cell 132 for transmitting energy when the operating energy interface 99 is connected to the operating energy counterpart interface 109.

On the machine frame 12 or on machine body 14, the base road construction machine 11 has a bearing interface 62, on which the support device 60 is attached by a bearing counterpart interface 64 situated on support device 60. In the illustrated embodiment example, the bearing interface 62 is symbolized by three coupling formations 62a, with which three coupling counterpart formations 64a of the bearing counterpart interface 64 of the support device 60 are coupled. By way of a threaded engagement or other engagement, the coupling formations 62a and coupling counterpart formations 64a may be fastened to each other.

The energy supply system 96 has a modular structure. In this way, the road construction machine 10 can be constructed in modular fashion with respect to its supply of working energy or working output and can be adapted to the respective customer preferences or boundary conditions of its use.

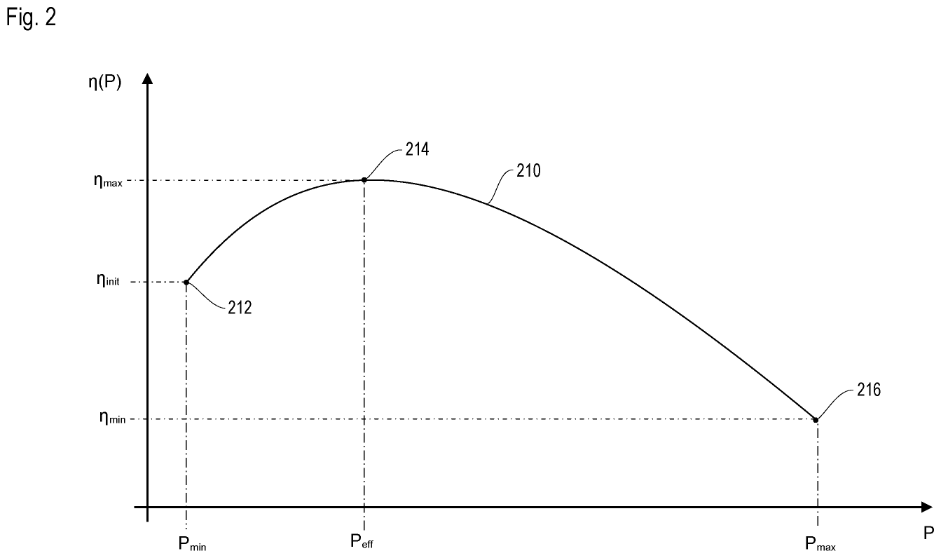

FIG. 2 shows qualitatively the characteristic curve of the efficiency factor n over the power P output by fuel cell 132. Graph 210 of FIG. 2 shows therefore qualitatively the characteristic curve of a factor for calculating a resource expenditure required for a quantity of energy output by fuel cell 132. The quantity of energy output is here the power output by the fuel cell 132 integrated over the relevant time span.

The minimum power Pₘᵢₙ that can be meaningfully and continuously delivered by the fuel cell 132 can be achieved at an initial efficiency factor ηᵢₙᵢₜ at operating point 212. Starting from operating point 212, the efficiency factor n increases up to a maximum value ηₘₐₓ at a particular operating point 214, at which a power value P_{eff} associated with the respective fuel call can be delivered continuously. At operating point 214, the fuel cell 132 can be operated with the lowest resource consumption per unit of power, for example per kilowatt. While the power output is not the highest at operating point 214, electrical power can be generated most effectively at operating point 214 with regard to the resource input required per unit of power generated.

Starting from the operating point 214 of highest effectiveness, the efficiency factor of the operation of the fuel cell 132 decreases with increasing power demand until the fuel cell 132 at operating point 216 delivers continuously its highest and thus maximum power Pₘₐₓ. As is typical for fuel cells, operating point 216 with maximum power output is also the operating point with the worst or lowest efficiency factor ηₘᵢₙ of the fuel cell 132 of the embodiment example.

The characteristic curve 210 is stored in a data memory accessible by control apparatus 38 and may be taken into account for controlling the energy supply system 96.

The present description of the operation of the control apparatus 38 for controlling the energy supply system 96 is highly simplified for better understanding and is to be understood merely schematically and qualitatively. The actually occurring control processes are substantially more complicated than described below. Much more data and characteristic curves are stored in the data memory accessible by the control apparatus 38 than merely the characteristic curve 210 of FIG. 2.

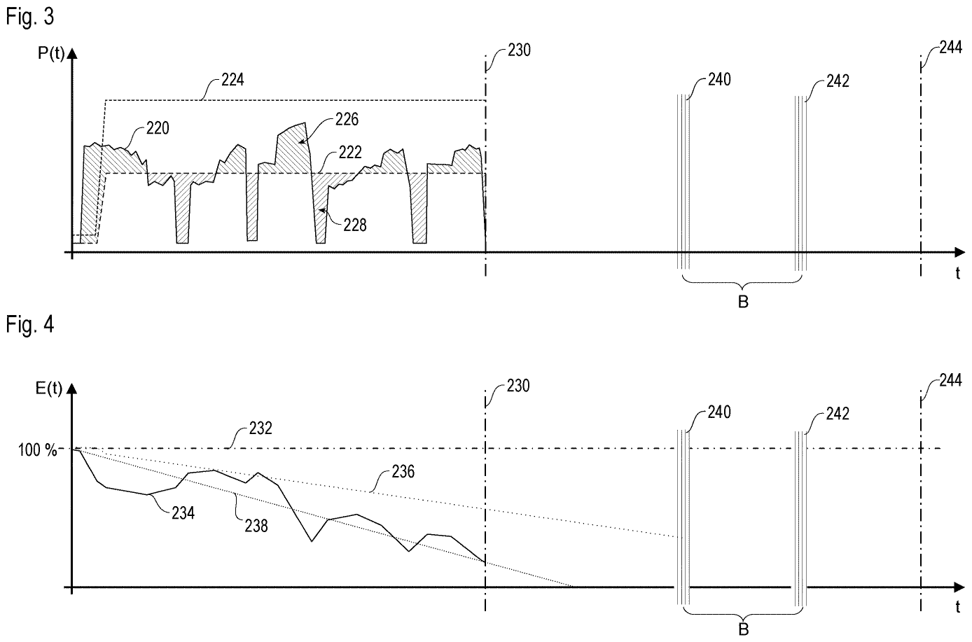

With the line 220, FIG. 3 is to illustrate in simplified and schematic fashion a power output P of the output shaft 78 of the electric motor 58 of the road construction machine 10 of FIG. 1 as a function of the time t during the performance of an earth work task, in this case: milling work on the ground.

The coarser dashed line 222 shows the power output of fuel cell 132. It is essentially constant during the work with the exception of an initial startup phase. Line 224, on the other hand, shows the maximum power Pₘₐₓ that can be delivered by the fuel cell 132. As illustrated in FIG. 3, the fuel cell 132 thus operates at approximately half of its maximum power, which in FIG. 2 corresponds to an operating point to the right of operating point 214, but somewhat close to the operating point 214. In any case, the operating point of the power of line 222 is markedly closer to the operating point 214 than to operating point 216.

The operating parameters of the function system 41, in particular of work module 40, were selected and set by control apparatus 38 on the basis of energy requirement information or remaining energy requirement information. For this purpose, the control apparatus estimated the energy required for completing the work task from the total volume to be removed, from the type of ground material input and from the available data about the tools deployed, and determined operating parameters that initially suggest that the on-board energy supply of the road construction machine suffices to complete the work task.

The irregular course of graph 220 of the output power stems from varying resistances of the ground to be removed along the forward motion path. For example, harder rock or harder asphalt may be present locally in the ground to be removed than was ascertained in random test drilling.

The hatched areas between the graph 220 of the power output at the output shaft 78 and the graph 222 of the power output by the fuel cell 132 indicates a change of the state of charge of the accumulator 130. Hatched areas with lines running from top left to bottom right, such as for example the area 226, are all above the graph 222 and indicate a discharge of the accumulator 130. In these areas, the electrical power output by fuel cell 132 does not suffice to produce the power required at the output shaft 78. The accumulator 130 must therefore contribute electrical energy in order to fulfill the power demand according to graph 220. The accumulator 130, controlled by the control apparatus 38 and by the control unit integrated into accumulator 130, is discharged.

In contrast, hatched areas with lines running from bottom left to top right, such as the area 228 for example, indicate operating phases in which the essentially constant power output over time of the fuel cell 132 exceeds the power required at the output shaft 78. Consequently, all of these areas lie below graph 222. In these operating phases, the control apparatus 38, in conjunction with the control unit 113 of the fuel cell 132 and the control unit integrated into accumulator 130, ensures an energy transfer from the fuel cell 132 into the accumulator 130. The accumulator 130 is therefore charged in these phases.

The regularly recurring, briefly dropping power demands may be attributable, for example, to the changing of trucks used to haul away milled material that is discharged by the road construction machine onto a transport truck via the conveyor belt described above during the earth work operation.

Since graph 220 plots power as a function of time, the integral of the power over time is the energy output. The hatched areas in FIG. 3 therefore represent, by their area, a measure for the quantity of energy drawn from or added to the accumulator 130.

The vertical dot-dash line 230 indicates the present moment of observation of the graph on the time axis. All events to the right of line 230 in FIGS. 3 to 6 are in the future, while all events to the left of line 230 in FIGS. 3 to 6 are in the past.

FIG. 4 shows in rough schematic fashion the existing reserve of energy in accumulator 130 for the operation of fuel cell 132 as a function of time t. For the sake of simplicity, the ordinate in FIG. 4 indicates the energy reserve as a percentage of the storage capacity of the respective storage medium. Line 232, as the 100% line, shows the maximum state of charge of the accumulator 130 as well as the maximum fill level of the fuel tank 100 of the fuel cell 132. In reality, a different energy content may and will be hidden behind the respective 100% lines of the various energy stores. However, the numerical value of the respectively stored amount of energy in a unit of measurement is not relevant here.

At the start of the work process, the accumulator 130 is fully charged and the fuel tank 100 of fuel cell 132 is fully filled.

The solid line 234 in FIG. 4 indicates the percentage of energy reserve remaining in accumulator 130 at a respective time t as the work progresses. This energy reserve is also referred to below as “state of charge”.

The dotted line 236 indicates the fill level of the fuel tank 100 at time t. Since, as shown by graph 222 in FIG. 3, the fuel cell 132 beyond the startup phase delivers a power output that is essentially constant over time, the fuel supply of fuel cell 132 decreases essentially in linear fashion with increasing work duration.

The accumulator 130, on the other hand, outputs energy in order to handle power peaks, the exact magnitude and duration of which cannot be precisely predicted. The state of charge of accumulator 130 therefore decreases in nonlinear fashion with increasing work duration. The progression of the fill level of the fuel tank 100 can therefore be predicted with greater accuracy, due to the essentially constant operation of the fuel cell 132 over time, than the development of the state of charge of the accumulator 100.

The more densely dotted line 238 indicates a straight trend line of the progression of the state of charge of accumulator 130 as a function of time, as can be ascertained, for example, by the method of least squares or by linear regression. Other methods for predicting the further progression of the state of charge of accumulator 130 are also possible, as an alternative or in addition. The trend line for predicting the future development of an energy reserve is not necessarily a straight line.

The time range 240 in FIGS. 3 and 4 indicates a time range in which the start of an operational break of the road construction machine 10 is expected because a wear indicator suggests that a wear limit of the milling bits used on the road construction machine 10 will be reached approximately in time range 240.

The duration B of a milling bit change for the milling drum used on the road construction machine 10 is known from past comparable operations. Hence, the end of the maintenance break for the milling bit change and the resumption of the earth work is expected in time range 242. The vertical line 244 in FIGS. 3 and 4 marks the end of the shift.

The trend line 238 in FIG. 4 indicates that, without further measures and with continued work operation, the accumulator 130 will be fully discharged even prior to the maintenance break expected between time ranges 240 and 242. Since the fuel cell, in its current operating state, cannot alone produce the power output at output shaft 78 required for the earth work over an extended period of time, the road construction machine 10 would come to a standstill due to the depleted accumulator 130 even before the start of the maintenance break. If the maintenance break then cannot be brought forward, for instance because necessary maintenance personnel and/or maintenance material are tied up elsewhere, the discharge of the accumulator 130 results in a substantial loss of productivity.

At best, an experienced and proactive machine operator can anticipate the impending excessive discharge of the accumulator 130 and, drawing on experience, modify the control of the machine in such a way that the impending loss of productivity is at least mitigated. However, the difficulty here lies in the fact that the trends illustrated in FIGS. 3 and 4 are not intuitively discernible, even to experienced operators, and, only in exceptional cases, can be retrieved and adequately analyzed at the control panel 36 on a short-term basis.

This is where the control apparatus 38 of the present disclosure, with its component controls described above, comes into play to proactively manage the operation of the machine 10, so that the amount of energy available in the on-board resources can be optimally utilized for the work task to be performed.

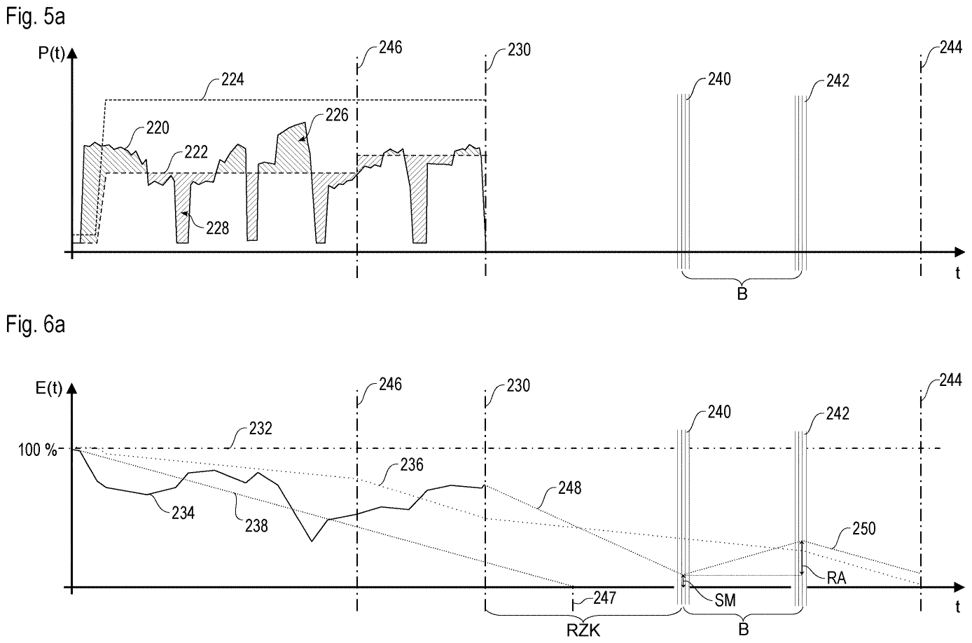

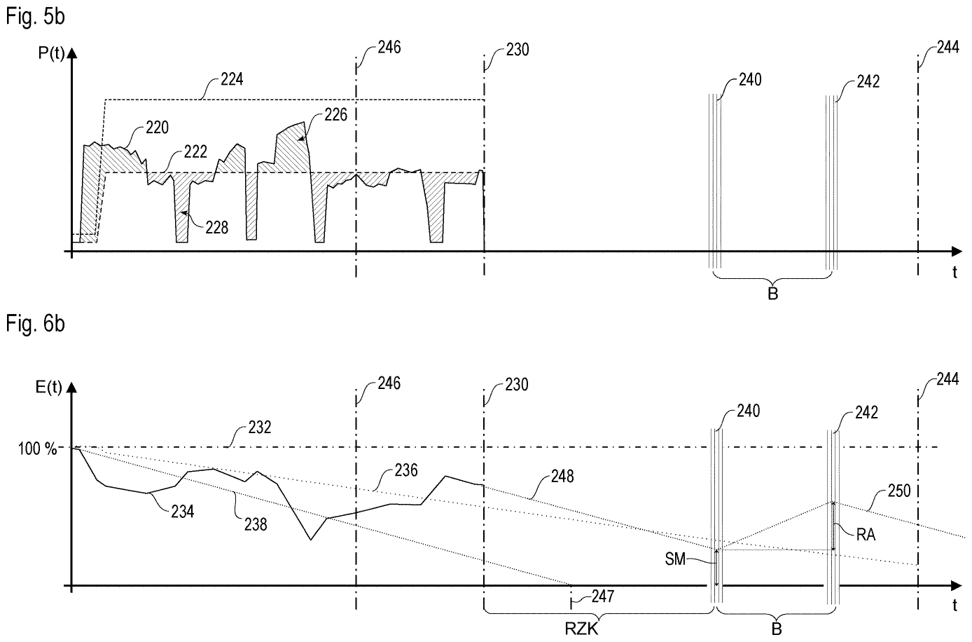

FIGS. 5a and 5b show essentially the same characteristic curve 220 of the amount of energy output at the output shaft 78 of the electric motor 58. FIGS. 5a, 5b, 6a and 6b are based on the same work task as in FIGS. 3 and 4, but with different control of the energy supply system 96 (FIGS. 5a and 6a) and of the function system 41, in particular of the work module 40.

First, regarding the pair of FIGS. 5a and 6a.

At time 246, the control apparatus 38 ascertains the trend line 238. This line intersects the abscissa at future time 247, which based on the operating parameters underlying the ascertainment of the trend indicates a complete depletion of the accumulator at time 247. The predicted time 247 of its complete depletion forms a first piece of remaining time information in the form of a remaining time potential. If the current operation continues, the accumulator can only output energy until time 247, but not beyond that point in time. In other words, the control apparatus 38 realizes by extrapolation that by maintaining the current operating parameters, the state of charge of the accumulator 130, as shown in graph 234, will most probably not suffice to complete the work task currently being executed. Rather, the accumulator 130 will be discharged prematurely.

The control apparatus 38 can ascertain the trend line 238 iteratively at specified time intervals or at specified times and project it into the future by extrapolation in order to check whether or not the state of charge of the accumulator 130 is sufficient for the work task currently being executed. The trend line 238 is thus an availability parameter within the meaning of the above disclosure, which represents the amount of energy deliverable by accumulator 130.

The control apparatus 38 detects the impending premature discharge of accumulator 130 and checks the fill level of fuel tank 100, represented by graph 236, as a further availability parameter, which represents the amount of energy deliverable by the fuel cell 132. In doing so, however, the respective efficiency factor of the fuel cell 132 must be taken into account in order predictively to calculate, as accurately as possible, the conversion of the quantity of fuel stored in fuel tank 100 into electrical energy. The efficiency factor of fuel cell 132 is known to and accessible by the control apparatus 38 in the form of the curve 210 shown in FIG. 2.

Furthermore, the control apparatus 38 takes into account the operational break for planned maintenance which in the case of continued operation is pending in the predicted time period 240. The period of time from the ascertainment time 246 up to the predicted time period 240 of a start of a technically necessary operational break constitutes a second piece of remaining time information, this time in the form of a remaining time quota RZK, for which an operational capability of the road construction machine 10 is to be maintained for the sake of maximizing productivity. By increasing the power output of the fuel cell 132 starting at time 246, the control apparatus 38 now attempts to extend the state of charge of accumulator 130 until the predicted start of the maintenance break in time period 240, and thus bring the remaining time potential into alignment with the remaining time quota RZK or even increase the remaining time potential beyond the remaining time quota RZK in order to maintain reaction reserves for unforeseen events with potentially increased energy consumption.

The control apparatus 38 is able to do this because the fill level of the fuel tank 100 is sufficiently high. The fill level of the fuel tank 100, represented for instance by graph 236, is also an availability parameter.

Due to the increase in the power output of fuel cell 132, illustrated in FIG. 5a by the upward step in graph 222, the accumulator 130 on the one hand is required, from time 246 onward, to contribute less electrical energy toward the execution of the work task, while, on the other hand, it is charged to a greater extent, since the segments of the power demand 220 lying below the graph of the elevated curve 222 increase, while the segments of the power demand 220 lying above the graph of the elevated curve 222 decrease.

Consequently, starting at time 246, the fill level of the fuel tank 100, represented by curve 236, decreases more rapidly per unit of time than it did prior to the change, because, on the one hand, more fuel is drawn due to the increased power demand placed on the fuel cell 132, and because, superimposed upon this effect, the fuel cell 132 is operated with a lower efficiency factor. At the same time, the curve 234 of the state of charge of the accumulator 130 changes due to the greater proportions of time spent storing electrical energy in the accumulator 130 starting at time 246, tending toward an increasing energy reserve, that is, a higher state of charge.

At time 230, which in FIGS. 5a and 6a is the time of observation of the diagrams, the control apparatus 38 detects that the state of charge of the accumulator 130 has been sufficiently restored so as to be able to operate the accumulator 130 with a certain safety margin SM through to time period 240, even in the event of a discharge trend 248 that is steeper than prior to the increase in power output of fuel cell 132 at time 246, at which point an operational break of the working apparatus 40 and essentially of the entire road construction machine 10 begins, which is expected to last until time period 242. Through its control intervention in fuel cell 132, the control apparatus 38 has successfully extended the remaining time potential beyond the remaining time quota.

The control apparatus 38 calculates that the amount of energy present in accumulator 130 at time 230 allows for energy withdrawal until the expected start of the operational break, which now permits a reduction of the power output of fuel cell 132. From time 230 onward, the fuel cell 132 can probably be operated at its operating point 214, optimal in terms of the criterion of energy efficiency, thereby extending the available fuel supply in fuel tank 100.

For the operational break between time periods 240 and 242, the control apparatus 38 ascertains the feasibility of charging the accumulator 130, by continuing to operate the fuel cell 132 at the optimal operating point 214 throughout the operational break, up to a state of charge that allows for the completion of the work task by the end of the shift 244, starting from the expected end of the operational break in time period 242 with the work task resuming under the initially selected operating parameters, while still retaining residual reserves of the state of charge of accumulator 130 and of fuel in fuel tank 100. More precisely, the control apparatus 38 calculates that during the operational break of duration B, with the operation of the fuel cell 132 at operating point 214, it is possible to increase the state of charge of the accumulator by a quantity of energy RA. The quantity of energy RA is a regeneration parameter in the sense of the above description.

The calculated residual reserves of state of charge and fuel afford the control apparatus 38 a certain margin for error in its forecast or accommodate a degree of uncertainty within that forecast. Since the slope of the trend curve 250 of the state of charge of the accumulator 130 starting with the expected resumption of work on the work task corresponds to the slope of the trend curve 238 at the start of the work on the work task, this forecast between the time periods 242 and 244 is based on a high degree of predictive reliability, as it is based on empirical values already obtained for the specific work task at hand.

Since the fuel cell 132 is to resume operation, from the end of the operational break onward, at the power output level demanded at the start of the work on the work task, the rate at which the fuel tank's fill level decreases would increase compared to the phase between time periods 230 and 242, during which the fuel cell 132 was operated at its efficiency-optimal point. This is reflected in a steeper slope of the expected fill level curve 236 starting at time 242, which corresponds to the slope prior to time 246.

For the time between the current time 230 and the expected start of the operational break in the time range 240, the control apparatus 38 assumes that a power profile of power output is required at the output shaft 78, which contains, at an average time interval of the time intervals of operational breaks that have occurred so far, such as due to truck changes, short operational breaks of a duration averaged over the durations of previous operational breaks, and in between exhibits a power demand corresponding to the power demands averaged over the last three preceding work cycles between respectively two consecutive short operational breaks. This is mentioned only as a possible simplified example to illustrate the ascertainment of such a forecast.

FIGS. 5b and 6b depict an alternative scenario, in which, at time 246, the control apparatus 38 manipulates, in response to the remaining time potential ascertained at time 247, the work module 40 instead of the fuel cell 132.

At time 246, the control apparatus reduces the rotational speed of the milling drum 44 and/or the forward motion rate of the road construction machine 10, thereby reducing the power input required by the work module 40. The graph 220 of the power delivered by the output shaft 78 therefore drops from time 246 onward, compared to the same work task in FIGS. 3 and 5a.

Due to the reduced power demand, for the same power output from the fuel cell 132, the proportion of operating phases during which the accumulator 130 is charged by the fuel cell increases starting at time 246, compared to the conventional control according to FIG. 3, while the proportion of operating phases during which the accumulator 130 is discharged decreases. As a result of this measure, the state of charge of the accumulator 130 decreases less or even increases. This leads to an increase of the remaining time potential.

As a second consequence of the reduction of the working output of the milling drum 44 or the work module 40, the operating phases are extended starting at time 246 until a specific event is reached, for instance a specific processing state of the ground or the filling of the truck for the removal of the milled material, of which less is now produced per unit of time due to the reduced power. Consequently, between time 246 and time 230 there are now only two operating phases, rather than three, as in FIG. 3 or in the example of FIG. 5a.

Moreover, with the milling drum operating at reduced working output, the milling bits of the milling drum experience less wear, shifting the start of required maintenance to a later time. The remaining time quota RZK in the example of FIGS. 5b and 6b is greater than that of the example of FIGS. 5a and 6a. Since, due to the reduced working output, wear decreases less sharply than the state of charge of the battery 130 recovers, the control apparatus 38 successfully increases the remaining time potential again beyond the increased remaining time quota RZK.

As a third consequence of the reduction of the working output of milling drum 44, the work task requires more time.

From time 230 onward, the work module is again operated with the same power demand as before time 246, since the state of charge of accumulator 130 has recovered sufficiently.

According to FIGS. 5b and 6b, a control intervention in the function system 41 or in work module 40 is indicated, for example, when the fuel reserve of fuel cell 132 or an energy parameter, such as e.g. the temperature of the fuel cell, does not permit an increase of the power output of the fuel cell 132.

The predictions of the control apparatus regarding the further development of the on-board usable energy correspond qualitatively to those described in relation to FIGS. 5a and 6a, since starting with the tool maintenance in time period 240, the expected further progression of the work task does not differ from that in the example of FIGS. 5a and 6a. The duration of the maintenance interval is independent of the preceding reduction of the working output of milling drum 44.

The control apparatus 38 can check whether the amount of energy RA accumulated in the accumulator 130 during the duration B of the maintenance interval together with the fill level of the fuel tank 100 following the conclusion of maintenance at time 242 allows for an increase of the working output of work module 40 relative to the operating state prior to time 246, in order to make up for at least a portion of the work backlog incurred between time points 246 and 230.

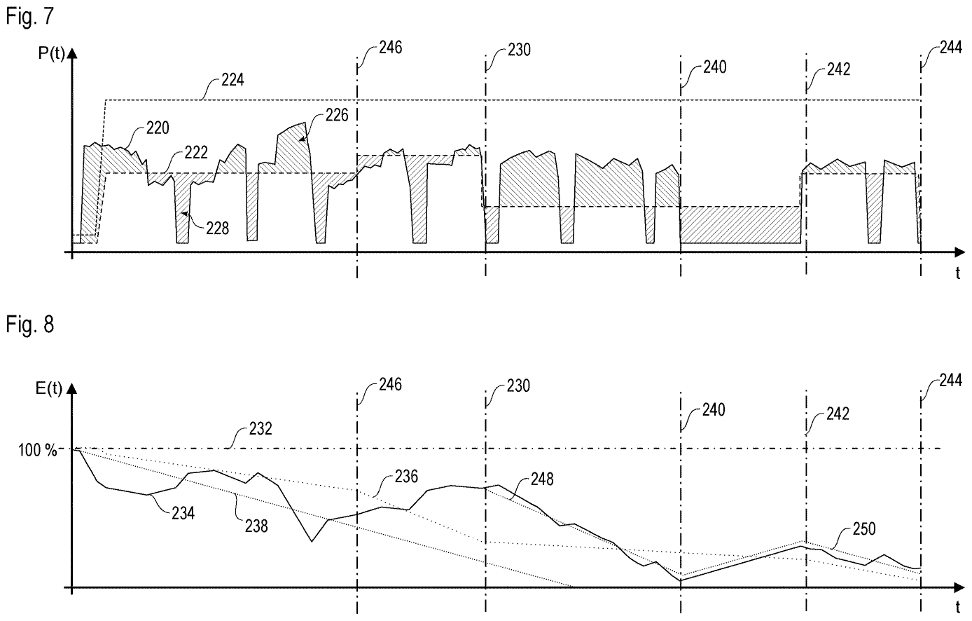

FIG. 7 shows the complete progression of the power outputs or power shifts during the entire work on the work task up to the end of the shift at time 244, in accordance with the first example depicted in FIGS. 5a and 6a.

Since the entire work process has now been concluded, in contrast to the diagrams of FIGS. 5 and 6 considered at time 230, the precise time points 240 and 242 of the start and the end of the operational break are known in the diagrams of FIGS. 7 and 8.

As can be seen from the diagram of FIG. 7, the operational break began upon the conclusion of a brief third operating phase following time 230.

FIG. 8 shows the progression of the usable energy supply on the road construction machine 10 in the form of the state of charge of accumulator 130 according to curve 234 and in the form of the fill level of the fuel tank 100, represented by curve 236.

As the progression of the state of charge of accumulator 130 shows at time 240, the start of the operational break, it is important to account for a safety margin, given that the actual state of charge had in fact fallen below the predicted state of charge at time 240.

Although the actual power output of the power system 58, represented in the present case by the output shaft 78 of the electric motor 58, will not, in the vast majority of cases, correspond exactly to the predicted power output, the control apparatus 38 presented in the present disclosure enables the operation of the road construction machine 10 to be controlled in such a way that the available amount of energy suffices for the stipulated operating duration and/or for the completion of a specified work task, if necessary, by extending the work time required for said task. This is achieved based on availability parameters, which represent the amount of energy deliverable by the energy supply system 96 and its individual energy supply apparatuses, and is further facilitated by advantageous knowledge of future operationally relevant events, such as for example a longer operational break and shorter operational breaks.

If, as in the example described above, the control apparatus 38 merely modifies the operation of the energy supply system 96 in order to conserve the amount of energy carried on board, there are generally no changes or only insignificant changes in the overall planned work time.

Additionally or alternatively, to manage the utilization of the available amount of energy, the control apparatus 38 can also modify the power output by the output shaft 78 or quite generally by the power system 56. This, too, can serve to ensure that a work task can ultimately be completed, a task which, in the absence of such control interventions, could otherwise not be finished due to an ensuing machine shutdown, even though the work time required to do so is typically extended, as more work cycles are necessary to fully complete the work task than would be the case without the control interventions. In most cases, however, it is more advantageous to complete a work task slightly later than planned than to have to carry the work task over into the next shift and complete it there due to machine downtime and possibly forced work breaks due to darkness and the like.

1-15: (canceled)

16: A road construction machine, comprising:
a machine frame;
a traveling gear configured to support the machine frame on a ground;
a function system supported by the machine frame and including a plurality of functional modules, including:
as a first functional module, a work module configured to work on a work object distinct from the road construction machine; and
as a second functional module, at least one travel drive configured to provide self-propelled movement of the road construction machine on the ground;
an energy supply system configured to supply the function system with energy; and
a controller configured to control at least the function system, the controller being further configured to control the function system and/or the energy supply system based at least in part on at least one availability parameter representing an amount of energy deliverable by the energy supply system.

17: The road construction machine of claim 16, wherein:
the at least one availability parameter includes or is a time-related availability parameter representing an amount of energy deliverable per unit of time by the energy supply system.

18: The road construction machine of claim 16, wherein:
the controller is configured to control the function system and/or the energy supply system based at least in part on:
at least one future operating event of the function system and/or of the energy supply system; and/or
at least one operating state of the function system and/or of the energy supply system.

19: The road construction machine of claim 16, wherein:
the controller is configured to control the function system and/or the energy supply system based at least in part on at least one piece of remaining time information representing a remaining operating time of the working module.

20: The road construction machine of claim 19, wherein:
the controller is configured to control the function system and/or the energy supply system in accordance with the availability parameter based at least in part on the at least one piece of remaining time information by a comparison between a remaining time potential and a remaining time requirement and/or a remaining time quota.

21: The road construction machine of claim 19, wherein:
the controller is configured to ascertain at least a portion of the at least one piece of remaining time information from at least one time information parameter, wherein the at least one time information parameter includes at least one of the following parameters and/or is ascertained based at least in part on at least one of the following parameters:
at least one function parameter of the function system;
at least one operating parameter of the function system;
at least one energy parameter of the energy supply system;
at least one work parameter of a work task currently performed and/or to be performed at a future time; and/or
at least one construction site parameter;
wherein the at least one function parameter represents at least one power consumption of at least one functional module;
wherein the at least one energy parameter represents at least one state parameter and/or at least one operating parameter of at least one energy supply system;
wherein the at least one work parameter represents information about a current and/or future work task yet to be performed; and
wherein the at least one construction site parameter represents information about a structure and/or organization of a construction site on which the road construction machine is deployed.

22: The road construction machine of claim 16, wherein:
the controller is configured to control the function system and/or the energy supply system based at least in part on at least one piece of remaining energy requirement information, wherein the remaining energy requirement information represents a remaining energy requirement of the road construction machine.

23: The road construction machine of claim 22, wherein:
the controller is configured to ascertain the remaining energy requirement information from at least one energy requirement parameter, wherein the at least one energy requirement parameter includes at least one of the following parameters:
at least one function parameter of the function system;
at least one operating parameter of the function system;
at least one energy parameter of the energy system;
at least one work parameter of a work task currently performed and/or to be performed in at a future time; and/or
at least one construction site parameter;
wherein the at least one function parameter represents at least one power consumption of at least one functional module;
wherein the at least one energy parameter represents at least one state parameter and/or at least one operating parameter of at least one energy supply system;
wherein the at least one work parameter represents information about a current and/or future work task yet to be performed; and
wherein the at least one construction site parameter represents information about a structure and/or organization of a construction site on which the road construction machine is deployed.

24: The road construction machine of claim 16, wherein:
the controller is configured to control the function system and/or the energy supply system by taking into account at least one regeneration parameter, wherein the at least one regeneration parameter represents an amount of energy that can be fed into the energy supply system.

25: The road construction machine of claim 16, wherein:
the function system requires energy of a predetermined form;
the energy supply system includes as a plurality of energy supply apparatuses either:
a) a plurality of different energy stores which respectively provide energy in the predetermined form;
b) a plurality of different energy converters which, on a basis of different physical principles, respectively convert energy provided in a form differing from the predetermined form of energy into the predetermined form; or
c) at least one energy store according to a) and at least one energy converter according to b);
wherein the at least one availability parameter respectively includes an apparatus-specific availability parameter for each energy supply apparatus of at least two energy supply apparatuses from the plurality of energy supply apparatuses, wherein the controller is configured to control the function system and/or the energy supply system based at least in part on the apparatus-specific availability parameters.

26: The road construction machine of claim 25, wherein:
the controller is configured to limit a power consumption of at least one functional module and/or increase an energy output of at least one energy supply apparatus.

27: The road construction machine of claim 26, wherein:
the controller is configured to combine an output of energy in the predetermined form by the plurality of energy supply apparatuses.

28: The road construction machine of claim 25, wherein:
the predetermined form of energy is electrical energy; and
the energy supply system includes at least two of the following energy supply apparatuses:
a battery;
a mains connection;
a fuel cell; and/or
a generator.

29: The road construction machine of claim 28, wherein:
the energy supply system includes a rechargeable battery and at least one further energy supply apparatus selected from the group consisting of a fuel cell, a mains connection, and a generator;
wherein the at least one further energy supply apparatus is configured to output energy to the rechargeable battery; and
wherein the controller is configured to control the output of energy by the at least one further energy supply apparatus to the rechargeable battery in order to charge the rechargeable battery.

30: The road construction machine of claim 16, wherein:
the work module includes a milling drum rotatable about a milling axis; and
the road construction machine is a road milling machine or a surface miner or a recycler or a stabilizer.
